(19) United States
(12) Patent Application Publication
(10) Pub. No.: US 2007/0217413 A1
(43) Pub. Date: Sep. 20, 2007

(54) Method For Assigning An IP Address To A Network Connectable Device, And A Device Configured Thereby

(75) Inventors: Dany Margalit, Ramat-Gan (IL); Yanki Margalit, Ramat-Gan (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN KNOWLEDGE SYSTEMS LTD., Tel Aviv (IL)

(21) Appl. No.: 11/736,013

(22) Filed: Apr. 17, 2007

Related U.S. Application Data
(63) Continuation-in-part of application No. 10/318,105, filed on Dec. 13, 2002.

(51) Int. Cl. H04L 12/56; H04L 12/28

(52) U.S. Cl. 370/389; 370/351

(57) ABSTRACT

A method of assigning a predetermined IP address to a device for installation on a private network. This IP address can be assigned before installation into any private network without having to be reassigned and without creating addressing conflicts, thereby simplifying the installation process. A registered global IP address is obtained from an Internet Registry and assigned to a multiplicity of devices. Exactly one such device is installed on the private network. The device has an internal router that captures data packets associated with the global IP address, so that this traffic is not put onto a public network connected to the private network. Because the registered global IP address is unique and intended for public networks, no other device on the private network has this address. Thus, the device's assigned IP address is guaranteed not to conflict with existing IP address assignments on the private network.

This is a continuation-in-part of U.S. patent application Ser. No. 10/318,105 filed Dec. 13, 2002.

### FIELD OF THE INVENTION

The present invention relates to the field of data network devices, and, more particularly, to a method for assigning a network address to a network device for installing in a private network.

### BACKGROUND OF THE INVENTION

The term “network connectable device” (NCD) herein denotes a device connected to, or intended for connection to, a private computer data network whose device addressing is based upon Internet Protocol addresses (IP addresses). The term “NCD class” is used herein to denote a class or group of such devices having similar or identical characteristics, and potentially encompassing a multiplicity of individual devices. When appearing without the “class” qualifier, the term “NCD” is used herein to denote a specific instance of an individual device.

A non-limiting example of an NCD class is the eSafe Hellgate HG-200 appliance product, manufactured by Aladdin Knowledge Systems (www.Aladdin.com), for analyzing network data traffic in order to detect viruses or other malicious data objects. A corresponding non-limiting example of an NCD is a particular instance of an eSafe Hellgate HG-200 appliance having a specific serial number, purchased by a specific customer for installation in a specific private network.

It is advantageous for both vendor and purchasers of an NCD class if the individual NCD's were distributed in a configuration that simplifies installation in private networks at their respective installation sites (e.g., at the purchasers'—the vendors' customers'—respective private network sites), in a manner similar to the familiar “Plug-and-Play” pattern. Ideally, the purchaser should be able to simply connect the NCD into the private network via plug-in cables, and proceed to use the NCD with minimal configuration effort. However, there is one parameter that must be set which involves potential inconvenience and troubleshooting, and consequently has a negative impact on the goal of simple installation. This parameter is the IP address of the NCD.

The NCD must be assigned an IP address to allow for communication with other devices on the private network. The assigning of IP addresses on private networks is published in RFC 1918—Address Allocation for Private Internets, the content of which is incorporated by reference as if set forth fully herein. In particular, section 3 of the above-cited document reads as follows (emphasis added to passages of special relevance to the present background and the present invention):

3. Private Address Space
The Internet Assigned Numbers Authority (IANA) has reserved the following three blocks of the IP address space for private internets:
10.0.0.0-10.255.255.255 (10/8 prefix)
172.16.0.0-172.31.255.255 (172.16/12 prefix)
192.168.0.0-192.168.255.255 (192.168/16 prefix)
We will refer to the first block as “24-bit block”, the second as “20-bit block”, and to the third as “16-bit” block. Note that (in pre-CIDR notation) the first block is nothing but a single class A network number, while the second block is a set of 16 contiguous class B network numbers, and third block is a set of 256 contiguous class C network numbers.
An enterprise that decides to use IP addresses out of the address space defined in this document can do so without any coordination with IANA or an Internet registry. The address space can thus be used by many enterprises. Addresses within this private address space will only be unique within the enterprise, or the set of enterprises which choose to cooperate over this space so they may communicate with each other in their own private internet.
As before, any enterprise that needs globally unique address space is required to obtain such addresses from an Internet registry. An enterprise that requests IP addresses for its external connectivity will never be assigned addresses from the blocks defined above.
In order to use private address space, an enterprise needs to determine which hosts do not need to have network layer connectivity outside the enterprise in the foreseeable future and thus could be classified as private. Such hosts will use the private address space defined above. Private hosts can communicate with all other hosts inside the enterprise, both public and private. However, they cannot have IP connectivity to any host outside of the enterprise. While not having external (outside of the enterprise) IP connectivity private hosts can still have access to external services via mediating gateways (e.g., application layer gateways).
All other hosts will be public and will use globally unique address space assigned by an Internet Registry. Public hosts can communicate with other hosts inside the enterprise both public and private and can have IP connectivity to public hosts outside the enterprise. Public hosts do not have connectivity to private hosts of other enterprises.
Moving a host from private to public or vice versa involves a change of IP address, changes to the appropriate DNS entries, and changes to configuration files on other hosts that reference the host by IP address.
Because private addresses have no global meaning, routing information about private networks shall not be propagated on inter-enterprise links, and packets with private source or destination addresses should not be forwarded across such links. Routers in networks not using private address space, especially those of Internet service providers, are expected to be configured to reject (filter out) routing information about private networks. If such a router receives such information the rejection shall not be treated as a routing protocol error.
Indirect references to such addresses should be contained within the enterprise. Prominent examples of such references are DNS Resource Records and other information referring to internal private addresses. In particular, Internet service providers should take measures to prevent such leakage.

The term “global IP address” herein denotes an Internet Protocol (IP) address within the “globally unique address space assigned by an Internet Registry” as particularly defined and specified in the above-cited published document, and is for use within the “Network Layer” (layer 3) of the OSI model. Accordingly, it is emphasized that the term “global IP address” is distinct from, and is not to be confused with terminology related to the “Data Link Layer” (layer 2) of the OSI model. The term “global IP address” is particularly distinct from terms that are different but similar-sounding, including, but not limited to the “global unique ID” (GUID) of the IEEE 1394 specification.

The term “registered global IP address” herein denotes a global IP address (as defined above) which has been uniquely assigned by an Internet Registry, as stipulated in RFC 1918. It is noted that various Internet organizations are involved in administering Internet address and name space, and organizational structures are subject to change. For example, “InterNIC” (the “Internet Network Information Center”) once offered domain name and IP address assignment but is now defunct as a registration authority. In place, ICANN (Internet Corporation of Assigned Names and Numbers) currently oversees the domain name registration industry and operates IANA. Accordingly, the term “Internet Registry” herein denotes and includes whatever authorities and authorized entities may have jurisdiction over the assignment of global IP addresses at the applicable time.

The term “private network” herein denotes a computer data network that complies with the definitions and characteristics as stipulated in RFC 1918 for computer data networks referred to therein as “private networks” and “private internets”. The term “network data” herein denotes any data which can be transported over a computer data network, and the terms “data packet” and “packet” herein denote units of data commonly referred to by these terms in the art, particularly as defined for TCP/IP.

When installing the NCD in a private network, a necessary requirement is that IP address of the NCD be unique within the private network. Thus, assigning an IP address to the NCD according to the guidelines of RFC 1918 without knowledge of the IP addresses already assigned to other devices on the private network can result in conflicts.

Therefore, it is not practical to assign an arbitrarily-chosen IP address to the NCD according to the guidelines of RFC 1918 prior to installation in a private network, because an arbitrarily-chosen IP address assigned to the NCD may already have been assigned to device previously installed on that private network. A consequence is that installing the NCD on a private network is typically carried out at the time of installation on the private network. By checking the IP addresses already assigned to devices on the private network, it is possible to choose a different IP address for the NCD that is currently being installed. Unfortunately, this necessity of checking existing IP addresses on the private network and if necessary choosing a new, unique IP address for the NCD being installed entails additional work and effort, and impedes the installation process.

In addition, setting the IP address of the NCD during installation is not always straightforward. Typically, NCD's do not require direct user-accessible data input for normal operation; most NCD's, therefore, are configured without a separate input means independent of the private network. NCD's also typically lack a convenient user interface. Connecting the NCD to a standalone computer typically involves a crossed cable connected to the NCD network card and the computer's network card. This is inconvenient and complicates the installation.

In another alternative prior-art solution, the NCD can be installed as a transparent bridge operating in the data link layer, which deals with the linking of two points. Installing the NCD between two linked points at the data link layer does not involve the network layer and does not require an IP address. Without an IP address, however, the NCD cannot be contacted over the private network and cannot be reconfigured.

Moreover, in addition to assigning an IP address to the NCD, other network devices on the private network must be properly notified of the IP address assigned to the NCD, in order for the other devices to be able to communicate with the NCD. This is a shortcoming of prior-art automated IP address assignment via the “Dynamic Host Configuration Protocol” (DHCP), because DHCP servers typically assign only a temporary IP address. When the IP address of the NCD is subsequently reassigned, notification has to be made again of the change, and thus there is the opportunity that not all devices will obtain the updated IP address of the NCD.

There is thus a need for, and it would be highly advantageous to have, a method by which an IP address can be pre-assigned to an NCD prior to installation in a private network, in such a manner as to avoid conflicts with IP addresses already installed on the private network, and thereby facilitate easy installation of the NCD in the private network by avoiding the need to check existing IP addresses and choose a non-conflicting IP address. This goal is met by the present invention.

### SUMMARY OF THE INVENTION

It is an objective of the present invention to provide a method for assigning a known IP address to an NCD prior to installation, which does not require any further involvement with IP addresses during installation in a private network, and which is guaranteed not to conflict with the IP addresses of existing devices already connected to the private network.

It is also an objective of the present invention to increase the ease of installing an NCD in a private network.

It is an additional objective of the present invention to provide a method for assigning a single known IP address to a multiplicity of NCD's, such as to an NCD class, such that each NCD of the multiplicity has the same IP address, but in a manner that does not cause addressing conflicts during use.

It is a further objective of the present invention to provide a method for assigning a known IP address to an NCD for installation in a private network which does not support DHCP.

It is a still further objective of the present invention to provide a method for assigning a known IP address to an NCD at a point of production of the NCD. The term “point of production” herein denotes a place and/or time during the production and/or distribution of the NCD prior to delivery to the purchaser or to the purchaser's private network. Points of production include, but are not limited to: manufacture; a factory or other manufacturing facility; warehousing; a stockroom or other warehousing facility; assembly and test; and vendor setup and configuration.

The present invention is of a method for assigning a known IP address to an NCD for installation in a private network such that no further operations regarding an IP address assignment are required during installation.

According to embodiments of the present invention, a registered global IP address is obtained and assigned to an NCD class at a point of production of the NCD class, so that upon receipt by the customer for installation in a private network, an NCD will already have a known IP address, so that no further IP address assignments are necessary. The NCD is further pre-configured at a point of production so that data packets referencing the global IP address are confined to the private network and are not placed on the Internet. Provided that no more than one such NCD is installed in a private network, therefore, the IP address of the NCD will never conflict with that of other devices.

Therefore, according to the present invention there is provided a method for assigning a known predetermined IP address to a network connectable device for installation on a private network, the method including: (a) obtaining a registered global IP address; (b) providing a plurality of network connectable devices, each of which includes: (i) at least one hardware port; and (ii) a processor operative to perform data operations, the processor connected to the at least one hardware port; (c) assigning the registered global IP address to each of the plurality of network connectable devices as the known predetermined IP address, such that the known predetermined IP address is the registered global IP address; and (d) installing on the private network exactly one network connectable device of the plurality of network connectable devices.

In addition, according to the present invention there is provided a network connectable device for connection to a private network, the network connectable device having a predetermined IP address on the private network, the network connectable device including: (a) at least one hardware port; and (b) a processor operative to perform data operations, the processor connected to the at least one hardware port and having a registered global IP address; wherein the predetermined IP address of the network connectable device on the private network is the registered global IP address.

Moreover, according to the present invention there is provided a network connectable device for connection to a private network, the network connectable device having a predetermined IP address on the private network, the network connectable device including: (a) at least two hardware ports; (b) a data channel between the at least two hardware ports, for transporting data packets; (c) a processor operative to perform data operations; and (d) an internal router operative to route data packets associated with a registered global IP address between at least one of the at least two hardware ports and the processor; wherein the predetermined IP address of the network connectable device on the private network is the registered global IP address.

### BRIEF DESCRIPTION OF THE DRAWINGS

The invention is herein described, by way of example only, with reference to the accompanying drawings, wherein:

FIG. 1 schematically illustrates a typical prior-art private network in which an NCD is installed.

FIG. 2 schematically illustrates a typical prior-art private network having an NCD installed, and connected to the Internet.

FIG. 3 is a flowchart of a method for assigning an IP address to an NCD for use in a private network, according to an embodiment of the present invention.

FIG. 4 is a conceptual block diagram of an NCD for use in a private network, according to an embodiment of the present invention.

FIG. 5 is a conceptual block diagram of an NCD for use in a private network connected to a public network, such as the Internet, according to an embodiment of the present invention.

### DESCRIPTION OF THE PREFERRED EMBODIMENTS

The principles and operation of a method and device according to the present invention may be understood with reference to the drawings and the accompanying description.

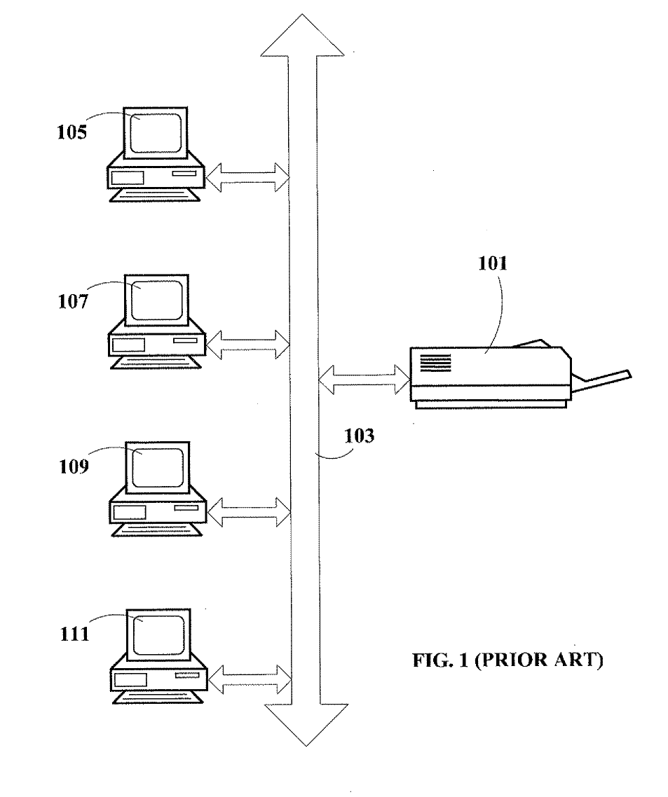

FIG. 1 schematically illustrates a typical prior-art private network in which an NCD 101 is installed. The private network is built around a Local Area Network (LAN) 103, to which other devices are connected, such as computers 105, 107, 109, and 111.

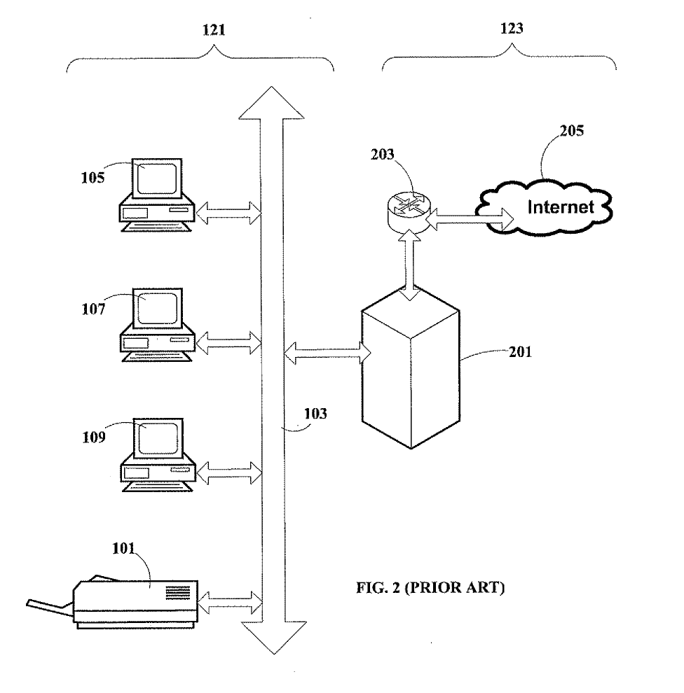

FIG. 2 schematically illustrates a typical prior-art private network in which an NCD 201 is installed, where NCD 201 is connected to a gateway device 203, which is connected to the Internet 205. Many important network devices are connected in a configuration similar to that of FIG. 2, with the device between the LAN (103) and the gateway (203).

The term “gateway” herein denotes any device serving as an entry point to another network, and includes, but is not limited to: servers; routers; and firewalls. Often for private networks, the other network connected via a gateway is a public network, such as the Internet. In the context of the present invention and the present application, the gateway to a private network is considered to connect the private network to a public network, such as the Internet. The term “router” herein denotes any device or component which redirects, controls, or selects the routing of data packets in a network environment, and includes, but is not limited to, devices referred to as “data switches” or “switches”.

The configuration of FIG. 2 is important, because many network devices are used to inspect, filter, or otherwise protect the private network from attacks present on the public network. An NCD such as NCD 201 is commonly used in this capacity, and, as such, must be connected in such a way that all traffic from the public network passes through the NCD for inspection, filtering, etc. In a common variation (not shown) of this configuration, NCD 201 is itself the gateway device for the private network.

Assigning an IP Address to a Network Connectable Device in a Private Network

The present invention is of a method for assigning a known and predetermined IP address to an NCD for installation in a private network in a configuration that includes, but is not limited to, the configuration shown in FIG. 2 for NCD 201.

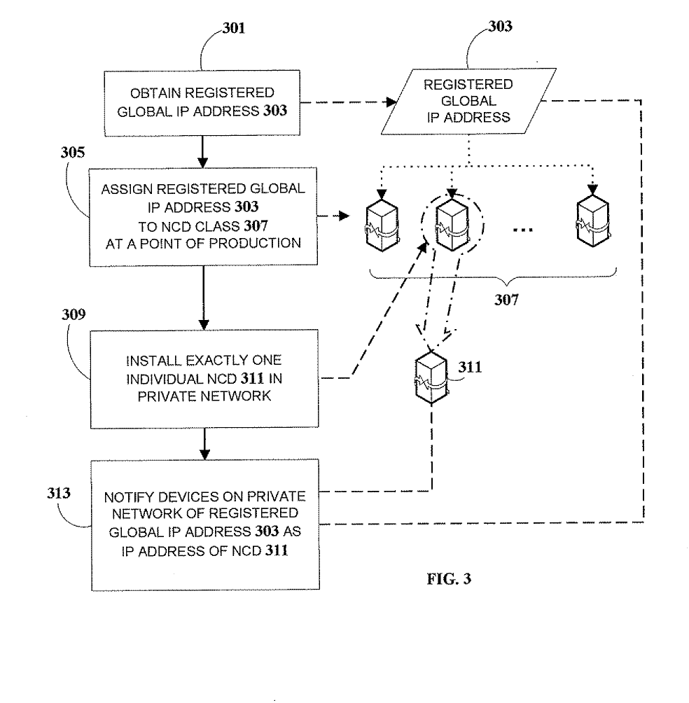

FIG. 3 is a flowchart of a method according to an embodiment of the present invention, for assigning a predetermined IP address to an NCD class 307.

In a step 301, a registered global IP address 303 is obtained from an Internet Registry, in compliance with RFC 1918. This is the predetermined, known IP address that will be assigned to a network connectable device according to the present method. In a step 305, IP address 303 is assigned to a multiplicity of devices in NCD class 307 at a point of production. It is emphasized that each device of the multiplicity of devices in NCD class 307 is assigned the exact same IP address 303.

In a step 309, exactly one individual NCD of NCD class 307, referenced in FIG. 3 as an NCD 311, is installed in the private network. To complete the method, in a step 313, devices on the private network are notified that NCD 311 is addressed on the private network via registered global IP address 303.

Connecting to a Private Network

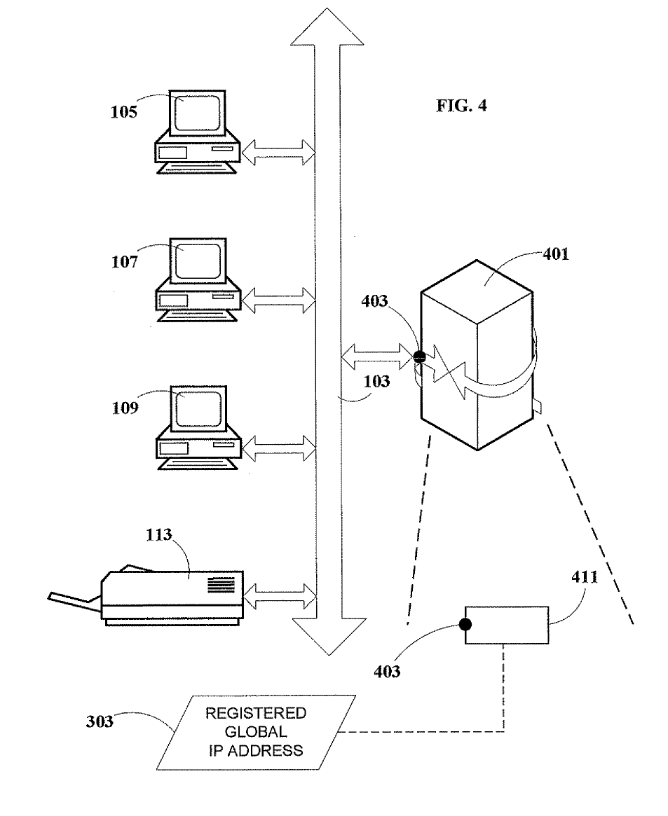

FIG. 4 is a conceptual block diagram of certain features of an NCD 401 according to an embodiment of the present invention. NCD 401 has a hardware port 403 which is connected to LAN 103. The term “hardware port” herein denotes a physical component which serves as a network data input/output point for a device. Internal to NCD 401 is a processor 411, which performs the data processing carried out by NCD 401. In an embodiment of the present invention, the IP address of NCD 401 is registered global IP address 303. In a functionally-equivalent embodiment of the present invention, the IP address of processor 411 is registered global IP address 303.

Because there is exactly one NCD on the private network having registered global IP address 303, there will therefore never be any address conflicts incurred by the assignment of global IP address 303 to a multiplicity of NCD's in NCD class 307 (FIG. 3).

Connecting to a Private Network Having a Gateway to a Public Network

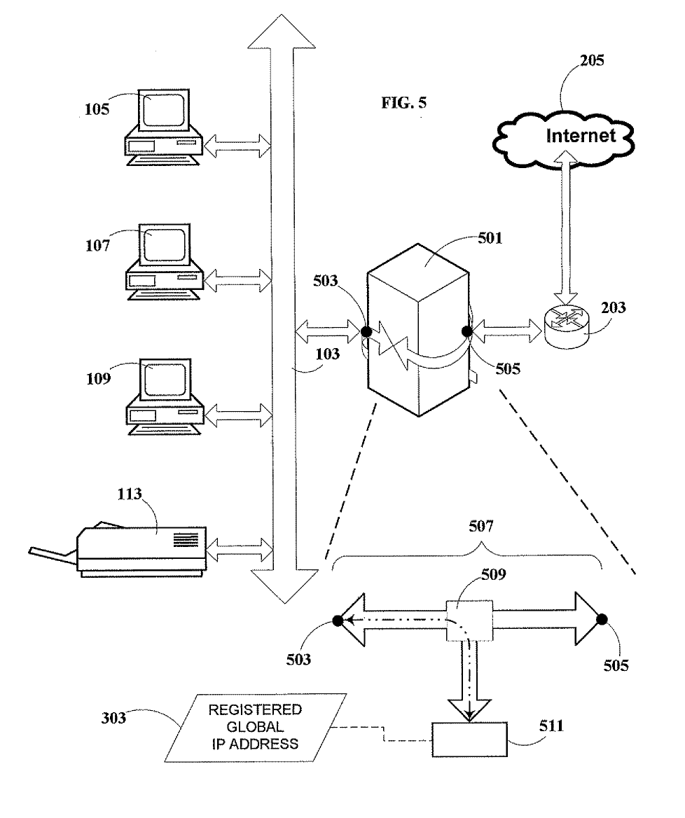

FIG. 5 is a conceptual block diagram of certain features of an NCD 501 according to a further embodiment of the present invention. NCD 501 has a hardware port 503 which is connected to LAN 103, and a hardware port 505 which is connected to gateway 203. Internal to NCD 501 is a data channel 507 between hardware port 503 and hardware port 505. The term “data channel” herein denotes a physical path for network data. Within data channel 507 is an internal router 509, which is capable of routing data packets traveling along data channel 507 to and from a processor 511, which performs the data processing carried out by NCD 501. Within NCD 501 on data channel 507, the IP address of processor 511 is registered global IP address 303.

Internal IP Address Routing Configuration of the NCD

Internal router 509 directs all data packets arriving at hardware port 503 and having registered global IP address 303 as their destination IP address to processor 511 as shown in FIG. 5. In addition, internal router 509 directs all data packets emanate from processor 511 and having registered global IP address 303 as their origin IP address to hardware port 503, as shown in FIG. 5. In this manner, data packets addressed to NCD 501 and sent by devices on the private network are captured by NCD 501 and are not sent to the public network (e.g., Internet 205). Likewise, data packets originated by NCD 501 are sent to the private network and not to the public network. Thus, using an NCD according to embodiments of the present invention, registered global IP address 303 is used in data packets which appear exclusively on the private network and never on the public network. Furthermore, because there is exactly one NCD on the private network having registered global IP address 303, there will therefore never be any address conflicts incurred by the assignment of global IP address 303 to a multiplicity of NCD's in NCD class 307 (FIG. 3).

In certain further embodiments of the present invention NCD 501 performs operations including, but not limited to: data monitoring; data inspection; data security analysis; and data filtering. Such operations are involved in providing increased data security for the private network from threats originating on the public network. In these embodiments, internal router 509 also directs all data packets arriving from gateway 203 to hardware port 205 to processor 511. Processor 511 carries out the desired operations, after which internal router 509 directs the processed data packets via data channel 507 to hardware port 503.

In an embodiment of the present invention, internal router 509 is a hardware device. In an alternate embodiment, internal router 509 is implemented in software within NCD 501.

While the invention has been described with respect to a limited number of embodiments, it will be appreciated that many variations, modifications and other applications of the invention may be made.

1. A method for assigning a known predetermined IP address to a network connectable device for installation on a private network, the method comprising:
obtaining a registered global IP address;
providing a plurality of network connectable devices, each of which includes:
at least one hardware port; and
a processor operative to perform data operations, said processor connected to said at least one hardware port;
assigning said registered global IP address to each of said plurality of network connectable devices as the known predetermined IP address, such that the known predetermined IP address is said registered global IP address; and
installing on the private network exactly one network connectable device of said plurality of network connectable devices.

2. The method of claim 1, wherein said plurality of network connectable devices is a network connectable device class.

3. The method of claim 1, wherein said assigning said registered global IP address is done at a point of production of said exactly one network connectable device.

4. The method of claim 1, wherein the private network has at least one additional device connected thereto, the method further comprising:
notifying the at least one additional device that said network connectable device has said registered global IP address.

5. The method of claim 1, wherein each of said plurality of network connectable devices further includes:
at least two hardware ports;
a data channel connected between said at least two hardware ports, for transporting data packets;
a processor operative to perform data operations, said processor connected to said data channel; and
an internal router operative to route data packets associated with said registered global IP address between at least one of said at least two hardware ports and said processor.

6. The method of claim 5, wherein said plurality of network connectable devices is a network connectable device class.

7. The method of claim 5, wherein said assigning said registered global IP address is done at a point of production of said exactly one network connectable device.

8. The method of claim 5, wherein the private network has at least one additional device connected thereto, the method further comprising:
notifying the at least one additional device that said network connectable device has said registered global IP address.

9. The method of claim 5, wherein the private network includes a LAN and a gateway to a public network, and wherein said installing on the private network comprises installing exactly one network connectable device between the LAN and the gateway.

10. The method of claim 9, wherein the public network is the Internet.

11. The method of claim 9, wherein said internal router is operative to capture a data packet from the private network addressed to said registered global IP address, such that said data packet does not reach said gateway to said public network.

12. The method of claim 9, wherein said installing on the private network comprises connecting one of said at least two hardware ports to the LAN, and connecting another of said at least two hardware ports to the gateway.

13. A network connectable device for connection to a private network, the network connectable device having a predetermined IP address on the private network, the network connectable device comprising:
at least one hardware port; and
a processor operative to perform data operations, said processor connected to said at least one hardware port and having a registered global IP address;
wherein the predetermined IP address of the network connectable device on the private network is said registered global IP address.

14. A method for configuring a private network, the method comprising:
providing a plurality of network connectable devices, each of which is a network connectable device according to claim 13; and
installing on the private network exactly one network connectable device of said plurality of network connectable devices.

15. The method of claim 14, wherein said plurality of network connectable devices is a network connectable device class.

16. The method of claim 14, wherein the private network has at least one additional device connected thereto, the method further comprising:
notifying the at least one additional device that said network connectable device has said registered global IP address.

17. A network connectable device for connection to a private network, the network connectable device having a predetermined IP address on the private network, the network connectable device comprising:
at least two hardware ports;
a data channel between said at least two hardware ports, for transporting data packets;
a processor operative to perform data operations; and
an internal router operative to route data packets associated with a registered global IP address between at least one of said at least two hardware ports and said processor;
wherein the predetermined IP address of the network connectable device on the private network is said registered global IP address.

18. The network connectable device of claim 17, wherein said internal router is operative to capture a data packet from the private network addressed to said registered global IP address.

19. A method for configuring a private network, the method comprising:
providing a plurality of network connectable devices, each of which is a network connectable device according to claim 17; and
installing on the private network exactly one network connectable device of said plurality of network connectable devices.

20. The method of claim 19, wherein said plurality of network connectable devices is a network connectable device class.

21. The method of claim 19, wherein the private network has at least one additional device connected thereto, the method further comprising:
notifying the at least one additional device that said network connectable device has said registered global IP address.

22. The method of claim 19, wherein the private network includes a LAN and a gateway to a public network, and wherein said installing on the private network comprises installing exactly one network connectable device between the LAN and the gateway.

23. The method of claim 22, wherein the public network is the Internet.

24. The method of claim 22, wherein said installing on the private network comprises connecting one of said at least two hardware ports to the LAN, and connecting another of said at least two hardware ports to the gateway.
